(19) United States
(12) Patent Application Publication
(10) Pub. No.: US 2008/0040130 A1
(43) Pub. Date: Feb. 14, 2008

(54) Method of distributing recognition and reinforcing organization focus

(75) Inventors: Gregg Lederman, Rochester, NY (US); Frederick A. Beer, Pitisford, NY (US)

Correspondence Address: SHLESINGER & FITZSIMMONS, 183 EAST MAIN STREET, SUITE 1323, ROCHESTER, NY, 14604, US

(73) Assignee: Potential Point, LLC, Rochester, NY (US)

(21) Appl. No.: 11/500,596

(22) Filed: Aug. 8, 2006

(51) Int. Cl. G06Q 10/00; G06Q 30/00

(52) U.S. Cl. 705/1

(57) ABSTRACT

A recognition distribution method also educates and focuses attention of organization members regarding a mission, strategy of an organization, such as a company, a partnership, a variant of a company or partnership, or even a religion, a club, or the like. Members and affiliates are encouraged to become participants in a program implementing the method. Participants are encouraged to nominate other members for recognition when the nominators (Witnesses) observe predefined Evidence (behaviors and experiences) conducted by the nominees. When a nomination is approved for reward, both Witness and recipient are given recognition rewards, preferably in the form of points they can redeem for goods. The method is preferably executed in a computer software application, such as a web-based system. Participant members access the application through standard web browsers and view context-sensitive pages that are different for each user and authorization level.

### CROSS-REFERENCE TO RELATED APPLICATIONS

None applicable.

### BACKGROUND AND SUMMARY

Many rewards type programs focus on hitting financial numbers or achieving company/organization goals and objectives. These programs rely on the “Carrot on the Stick” model to get customer employees to reach growth targets. They do not have the idea of educating and training members about company strategy and business objectives through recognition of individuals who nominate others for awards (the “Witnesses”), as well as those who are nominated, if they even allow such nominations.

In these prior art systems, not everyone in the company can typically participate. Programs typically are targeted to reward a select few high performers in job categories within a company. Programs are typically short-lived, fizzling out over time as rewards become meaningless or entitlements that frustrate management. Often, the same people are rewarded over and over again, which can be a de-motivator for good performers who are trying to be great, yet receive no recognition.

Thus, existing programs can create unhealthy competition, diminishing productivity and teamwork. They give rewards for easily quantified things, such as hitting sales targets, lowering “return rates,” improving defect numbers, and the like. Such do not have the ability to reward the softer skills such as proprietary, trained behaviors that are essential for enabling a company or organizational strategy. Further, the existing programs do not educate people on the how behind the what in a strategy or why it matters. Embodiments tie these points of understanding and education to bottom line results.

The recognition program of embodiments is based on tactical, industrial age activities and goal achievement. Getting people to contribute to achieving a company strategic initiative by helping them understand it, commit to it, and take the right actions to accomplish it. Embodiments strive to overcome the lack of recognition and reward opportunity for people who recognize others who are being successful by allowing those who see success in others to nominate them for recognition. This helps to close the knowing/doing gap that is pervasive in companies today. In embodiments, the person who submits a nomination (the Witness), is also recognized and rewarded for submitting the nomination, which indicates that the Witness knows the organizational strategy. In most implementations, the Witness can receive a greater reward than the Steward. Thus, in embodiments, the nominator and the nominated both receive recognition for knowing and doing the organizational strategy.

Additionally, embodiments overcome the struggles of companies and other organizations to conveying the organizational strategy to their member by educating and training people while they are executing the strategy. Since it is difficult to tie the success of individual employee behaviors to company results, embodiments enable monitoring and reporting of company or organizational results beyond sales figures and other easily quantified statistics. Instead, the approach of embodiments is to quantify not only the hard stuff, but also the “soft” stuff, that which is typically judged to be intangible, such as the behaviors of people in the organization. Embodiments can overcome the difficulties of prior art programs with participation in the program and can achieve high percentages of participation for years.

### BRIEF DESCRIPTION OF THE DRAWINGS

FIG. 1 shows a schematic flow diagram of a method according to embodiments.

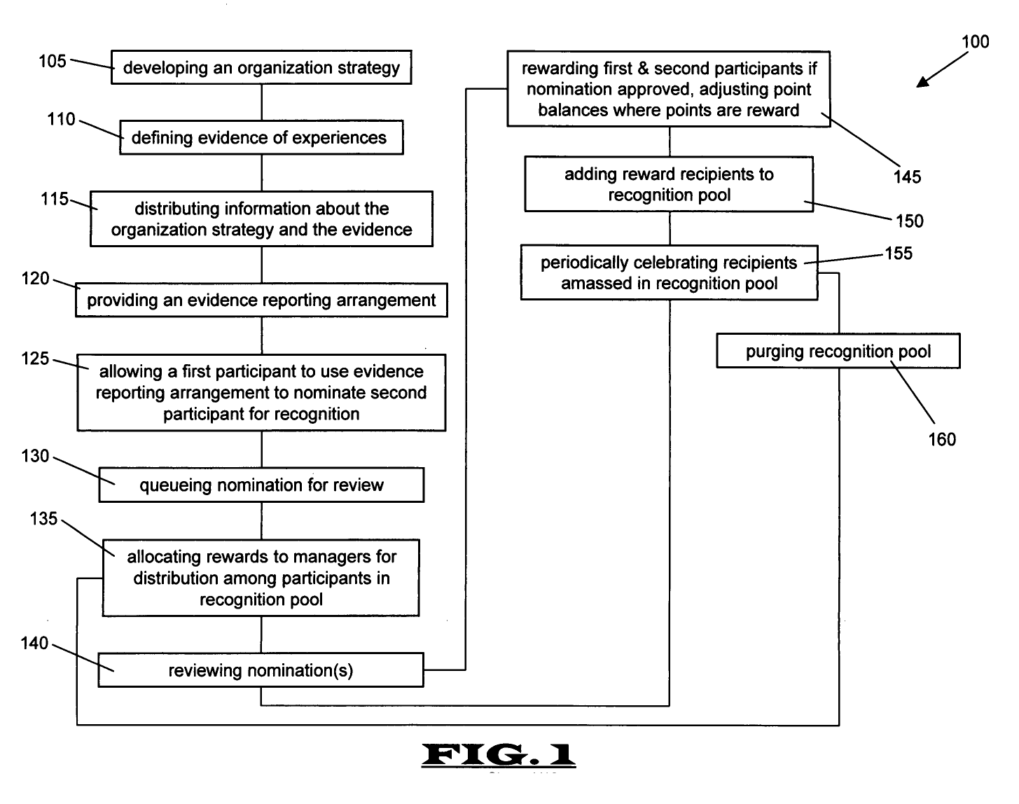

FIG. 2 shows a schematic flow diagram of a method of implementing a method according to embodiments.

FIG. 3 shows a schematic representation of a browser window displaying an organization strategy overview/description page of embodiments.

FIG. 4 shows a schematic representation of a browser window displaying an employee home/portal page of embodiments.

FIG. 5 shows a schematic representation of a browser window displaying an Evidence sought viewing page according to embodiments.

FIG. 6 shows a schematic representation of a browser window displaying a nomination form page of embodiments.

FIG. 7 shows a schematic representation of a browser window displaying a reports page of embodiments.

FIG. 8 shows a schematic representation of a browser window displaying a recognition pool manager page of embodiments.

FIG. 9 shows a schematic representation of a browser window displaying a nomination review page of embodiments.

FIG. 10 shows a schematic representation of a browser window displaying a reward redemption page of embodiments.

### DESCRIPTION

With reference to the accompanying FIGS., embodiments, which can be performed by a computer software application, comprise a method of distributing recognition and reinforcing organizational focus 100 including developing an organization-wide strategy 105, preferably based on beliefs that drive employees to engage in observable behaviors. “Behaviors” are preferably actions, functions, and/or performances by individuals in the organization. Behaviors can include, for example, activities one can see another doing, or an observable action by an individual that is driven by the individual's beliefs and attitudes. The method of embodiments can include defining “Evidence” of Experiences 110. “Evidence” preferably comprises the observable outcome of one or more behaviors and or experiences. This behavior or experiences lead to encounters an individual has with a company, its employees and/or products and services that engages them on a physical, emotional, intellectual, and or spiritual level. The method of embodiments can include distributing information about the organization strategy and Evidence 115. Such Evidence can thus become an event or events in which employees and customers participate passively or actively. Embodiments encourage positive employee and customer experiences (the Evidence) because it can, when positive, deliver the benefits of the strategy in ways that motivate people to take action. In other words, Evidence can lead to increased employee productivity, customer and employee loyalty, and acquisition of new customers.

The mission, vision, values, and strategy as stated by the organization provides the data necessary to be entered into a software application that acts as a portal for the strategy as will be described below. The data is preferably in the form of nominations by individuals of others seen engaging in the desired behaviors. In order to recognize the behaviors, individuals must learn the strategy, and embodiments encourage participants to take action by recognizing those who observe desired behaviors in others as well as those who engage in the desired behaviors. For the purposes of this application, “organization” refers to a company, partnership, any variant of these, churches and other religious establishments, civic organizations, clubs, and any other entity in which individuals participate that can have an organization strategy, focus, and mission. Embodiments focus on companies, such as corporations and partnerships, but can be applied to any suitable organization.

Preferably, embodiments are carried out by a computer software application since such applications can easily manipulate vast quantities of data in short period of time. However, it is conceivable that the method of embodiments could be performed by one or more people instead of a computer. Where a software application is employed, the software is charged with monitoring and reporting on employee progress and communicating successes of participation. The software of embodiments also tracks participation and indicates potential bottom line results.

Embodiments comprise providing an evidence reporting arrangement 120 and allowing individuals (Witnesses) to nominate others (Stewards) for recognition 125, then sending the nomination for review 130. Preferably, the method includes allocating rewards to managers for distribution among participants in a recognition pool 135. Reviewing nominations 140 can be conducted by a manager or the like, but this could be automated as part of the software application. Rejecting the nomination can result in nothing or can trigger notifying the Witness that the nomination has been rejected, thus creating a learning moment where the witness can resubmit the nomination. Approving the nomination results in sending the approved recognition into a Recognition Pool 150. Rewarding 145 can include adjusting point balances, particularly when embodiments provide immediate awards of points to Stewards and/or Witnesses. The recognition pool is the accumulation of approved recognition/awards, and embodiments can include reviewing the pool on a periodic basis, such as by a team of managers and/or executives on a scheduled basis such as monthly, quarterly, or semi-annually, for determining which nominations result in awards of points to the respective Stewards and Witnesses, which points can be redeemed for rewards via offline or online distribution sources. Celebrating the awards 155, such as with a lunch and learn workshop or company party, draws attention to the rewards involved in learning the organization strategy, thus encouraging participation and greater understanding of the strategy. Embodiments can include purging the pool 160, such as after awards are delivered or at other times as may be deemed necessary or appropriate, or can retain nominees, such as for the next periodic review or even until the program is terminated. Preferably, the nominations remain in the pool for a predetermined period that can be defined by the organization using embodiments, and the organization can purge the pool at any time or have a nomination expire from the pool after a preset amount of time.

Reviewing the recognition pool includes providing a predetermined number of points to each reviewer 135. Preferably, providing points 135 comprises providing a first number of points to a first level of management, a second number of points to a second level of management, a third number of points to a third level of management, and additional numbers for additional levels of management if desired. For example, a manager might receive 100 points, a director 200 points, and an executive 300 points. The reviewing team proceeds according to embodiments by allocating points to employees based on the Evidence gathered. Evidence includes proof that the Witness understands and recognizes the Steward for doing behaviors and experiences that drive positive organizational results.

Embodiments include providing a Strategy Champion who is a designated authority on the organizational strategy. The Strategy Champion, in addition to being a resource for information regarding strategy, oversees the system, which includes helping to prevent fraud. Reviewing 140 preferably further comprises submitting the point-allocated recognition pool to the Strategy Champion, redistributing points if necessary to ensure reasonable distribution within the organization, and making the point allocations available to employees, such as by publishing the information on a web page, or via a message, such as a memo, letter, or email.

Celebrating Recognized Behaviors 155 can include providing workshops to celebrate successes, stimulate continued participation, and recognize and reward individuals for delivering results. In embodiments, providing workshops includes providing a program launch workshop and providing at least one milestone workshop. Providing a program launch workshop preferably includes providing preparatory work for participants, leading the workshop jointly with organization chief and program provider, and starting the workshop with a review of the organization strategy. The workshop further includes introducing the concept of Evidence and its impact on organizational success, introducing and explaining the reports program participants will receive, and providing post-workshop work in the form of a series of tasks and or a competition to kick off the program.

Each milestone workshop preferably includes sharing successes of participants and the organization and the impact the successes have on organizational performance. Presenting awards, forming teams, and starting a contest can be included in the milestone workshops according to embodiments. Further, introducing lunch and learn themes around strategy or Evidence concepts can be included in the first milestone workshop.

A particular embodiment includes three milestone workshops, the third of which adds voting for grand prize winners in the contests, voting for a productivity enhancing winner, and voting for a new business winner. These additional steps could be included in every milestone workshop after the first since contests are preferably started with each milestone workshop. The first milestone workshop can be held, for example, at three months into the program, the second at eight months, and the third at twelve months, but other time periods can be used as might suit a particular program and/or organization.

Publishing reports according to embodiments preferably includes publishing usage patters of the system to monitor and stimulate participation in the program and understanding of the strategy. Publishing reports can further include publishing the performance impact by displaying what business result areas are most and least recognized and/or by displaying how many points are allocated/budgeted across the organization. Further, specific issues, such as “Siloing” and the like, can be identified, measured, and fixed.

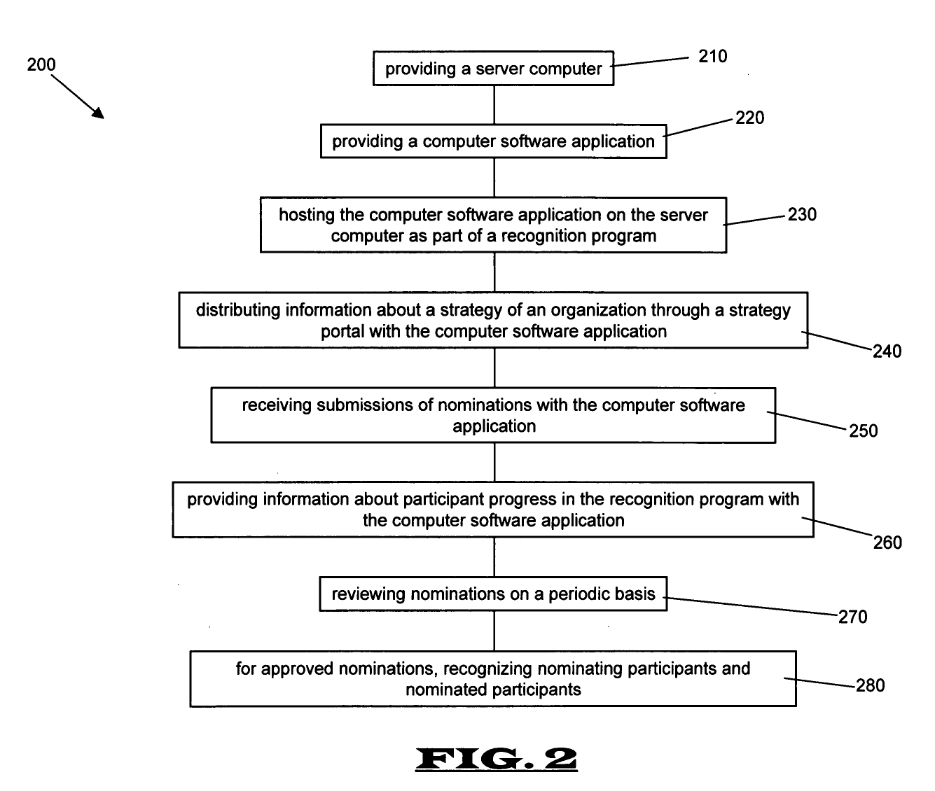

In the software implementation of embodiments, a web-based system using a scripting language, such as Ajax, php, perl and/or Python, a mark-up language, such as XML, SHTML, XHTML, and/or HTML, and/or a database, such as Microsoft SQL Server or MySQL, is preferred. Various combinations of these components can be used where appropriate. The method of implementing in embodiments, as seen, for example, in FIG. 2, comprises providing a server computer 210, providing a software application that executes the method of recognition 220, and hosting the computer software application on the server computer as part of the recognition method 230. Thus, in embodiments, the program is preferably installed and hosted on a server computer connected to an intranet or to the internet. Participants can then access the program with a web browser or the like from any computer with access to the same network to which the server computer is connected.

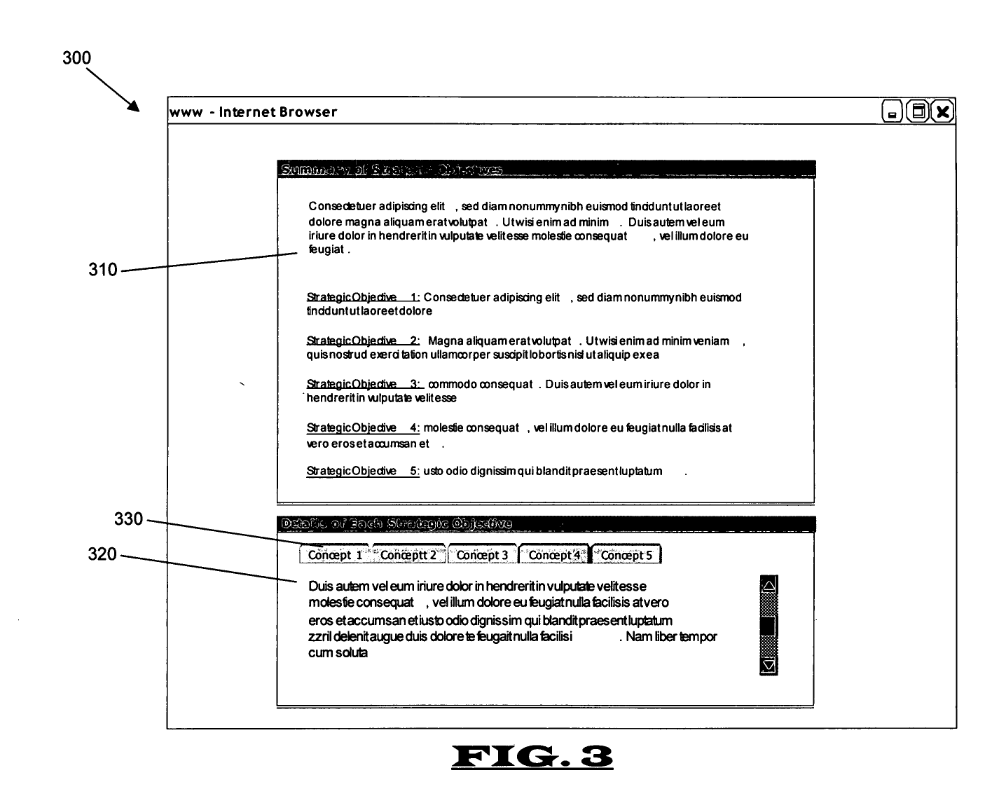

An organizational strategy according to embodiments is preferably made available to users via a strategy overview page accessible via a web browser application or other suitable viewing application. An example of a strategy overview page 300 is seen in FIG. 3, and can include a summary of objectives of the strategy 310 as well as details of each objective 320, and can include links, menus, tabs, or other suitable navigation tools 330 to allow users to move to different parts of the explanation of the strategy. The method of implementing thus further comprises distributing information about the organization strategy with the software application 240.

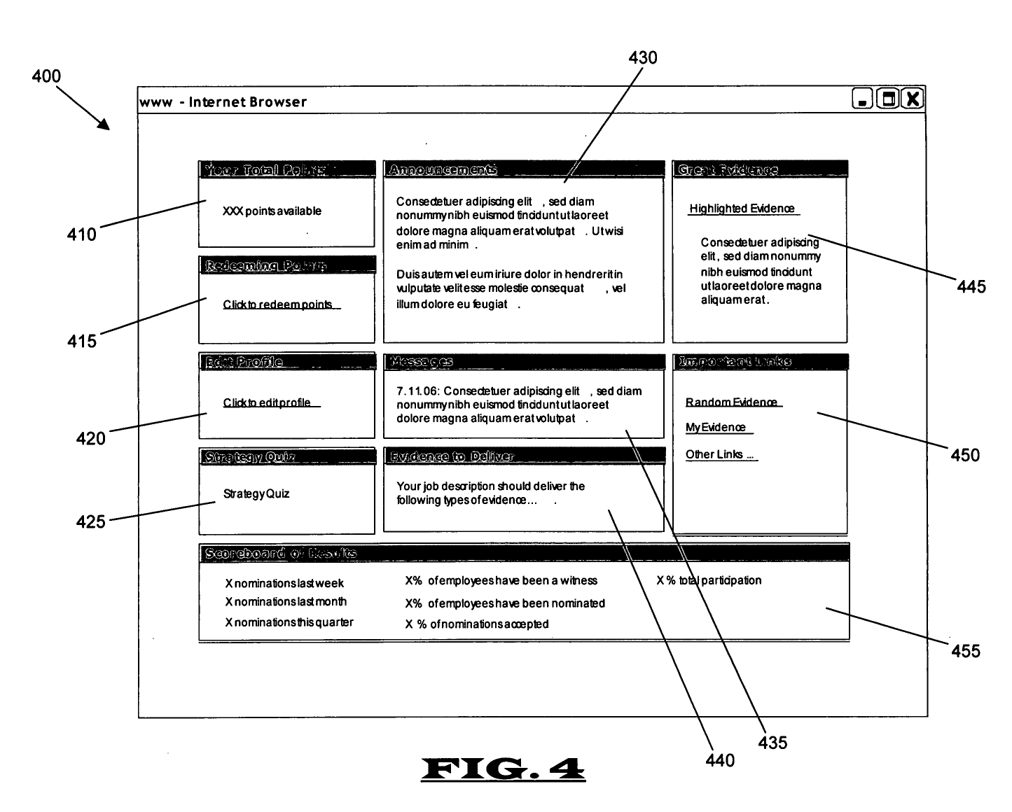

In embodiments, each user, whether the user is a participant, an administrator, a manager, or another type of user, has a home or portal page 400, such as that shown in FIG. 4. The method of implementation preferably includes providing information about participant progress 260, so the home page 400 preferably includes a sections notifying the user of point balance 410 and/or how to redeem points 415. The home page 400 preferably also includes sections displaying how the user can edit user profile 420, system announcements 439, messages received 435, and Evidence the user should seek to deliver 440. Additionally, the home page 200 can include a highlighted Evidence or Evidence important to the organization section 445, and an important links section 450 that can include links to the user's Evidence, a link to view random Evidence, a link to more links, and/or other links the program administrators wish to place in the section. The particular sections displayed will preferably vary with user permissions (participant, manage, executive, etc.). Embodiments of the method of implementation include receiving submissions of nominations with the software application 250. Thus, the home page 400 will include a link or section with which the user can reach a nomination form or the like. All user home pages preferably include a navigation section with links to other pages in the program site, though again this will vary with user permissions. For example, the navigation section can provide participants with links to the strategy and objectives Evidence page 500, the nomination page 500, a quizzes page, the program/strategy overview page 300, and a reports page 700. For participants in the program, the participant's accrued points can include, if the participant is part of a team, the team's accrued points. Additionally, the home page 400 can include a “scoreboard” section 455 in which various statistics related to nominations overall and by team can be displayed. The various sections can include links to pages in which more details and/or a more complete record of the type of information can be viewed. For administrators, additional features are preferably provided that allow editing of the various sections according to the particular permissions each administrator has.

The message section 435 preferably includes links to messages received. For participants, the message section 435 can display whether the participant has been nominated for recognition and/or the outcome of a nomination submitted by the participant. Similarly, a manager's message section 435 can display whether the manager has received new nominations to review.

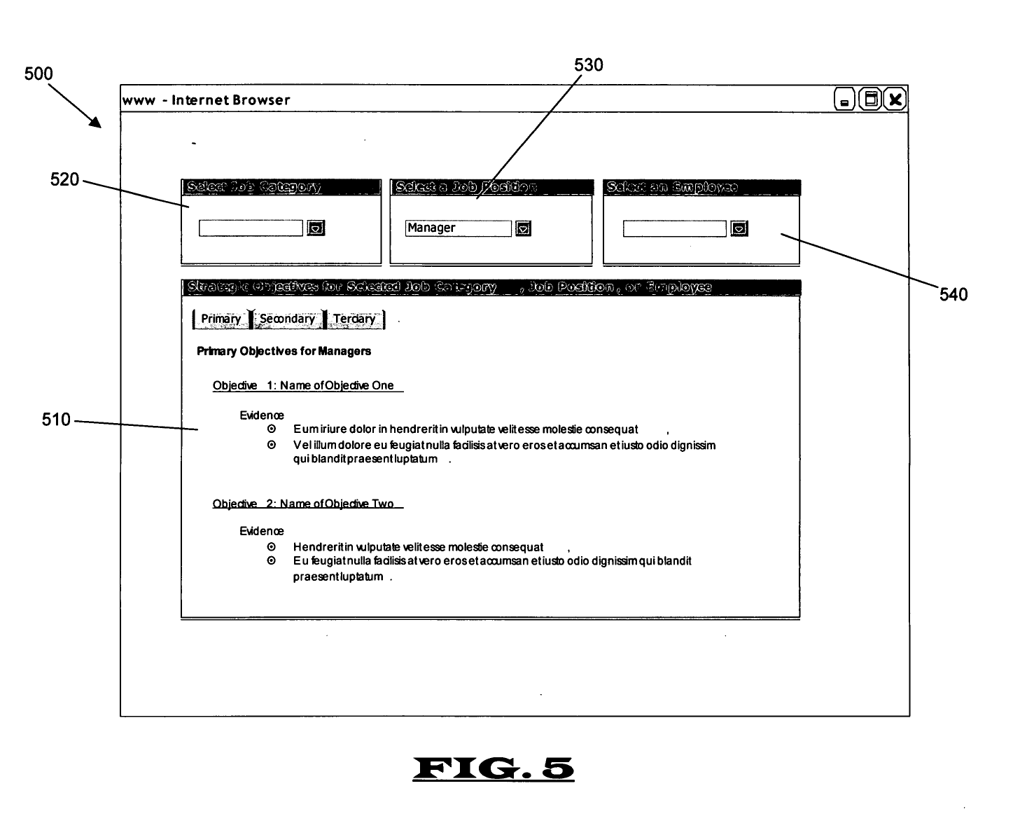

The section presenting Evidence the user should seek 440 preferably includes text suggesting that the user should seek listed Evidence. Embodiments present at least one link to a description of Evidence to be sought, the text of the link preferably including a title for the Evidence, preferably described in terms of behaviors. When the user clicks the link, embodiments display a detailed description of the Evidence and what it entails, such as by pop-up window or by displaying an appropriate section of the Evidence detail page 500. In this section, embodiments preferably provide one or more such Evidence links randomly selected from a group of Behaviors and or Experiences based on the job of the user logged into the system. Additionally, the Evidence detail page 500 can allow a user to view the types of Evidence sought of other users by selection of job category, job position/tile, and/or employee name, as seen, for example, in FIG. 5, as will be described below.

The section presenting Evidence important to the organization 445 preferably presents a random item selected from success stories, featured strategy concepts, or other Behaviors the organization values. Additional items can be listed in embodiments, if desired. The nomination link can be included in this section, in the links section 450, another section, or can have its own section.

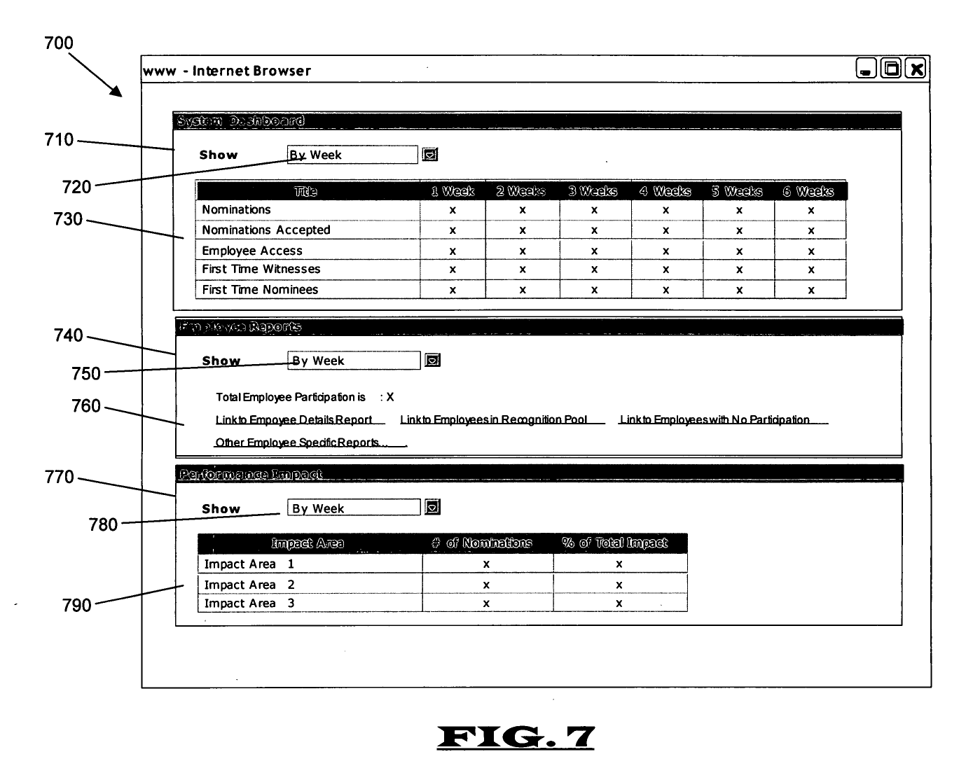

The home page could also include a section presenting Behaviors and Evidence that other users are delivering by displaying a random item in the same manner as the organizationally important Evidence section. Alternatively, this information could be shown in a separate page, such as the reports page 700 of FIG. 7. Embodiments including such display of information preferably allow a user to select from a plurality of views, including random, “great” Evidence, and Evidence the user prefers to view.

When the user clicks the more details link from the Messages section, the user is presented with a completed nomination form showing the Witness, Steward, name of The Evidence supporting the nomination, a description of The Evidence supporting the nomination, and bottom line impacts of The Evidence and Behaviors on the organization.

When the user clicks the more details link from the “Evidence the user should seek” section, the user is presented with a page including, for example, descriptions of the Evidence specific to the user's job description, such as that shown in FIG. 5. The Evidence detail page 500 of embodiments can include a list of organizational objectives and other general information, as well, or can link to such information in a strategy overview page, such as that shown in FIG. 3. For example, the Evidence detail page can begin with an overview of the job category 510 with a bullet list or the like of beliefs, behaviors, and experiences of the job. The elements can be hot linked to detailed descriptions of the elements either on the same page, in a pop-up window or the like, or other form as may be desired. It should be noted that different job categories may very well share elements of the same title, but that the detailed description of such elements can vary with the job category being described. Embodiments preferably provide sections of the page allowing the user to view the relevant sought Behaviors and Evidence of other job positions, such as by category 520, position 530, employee 540, or other structure.

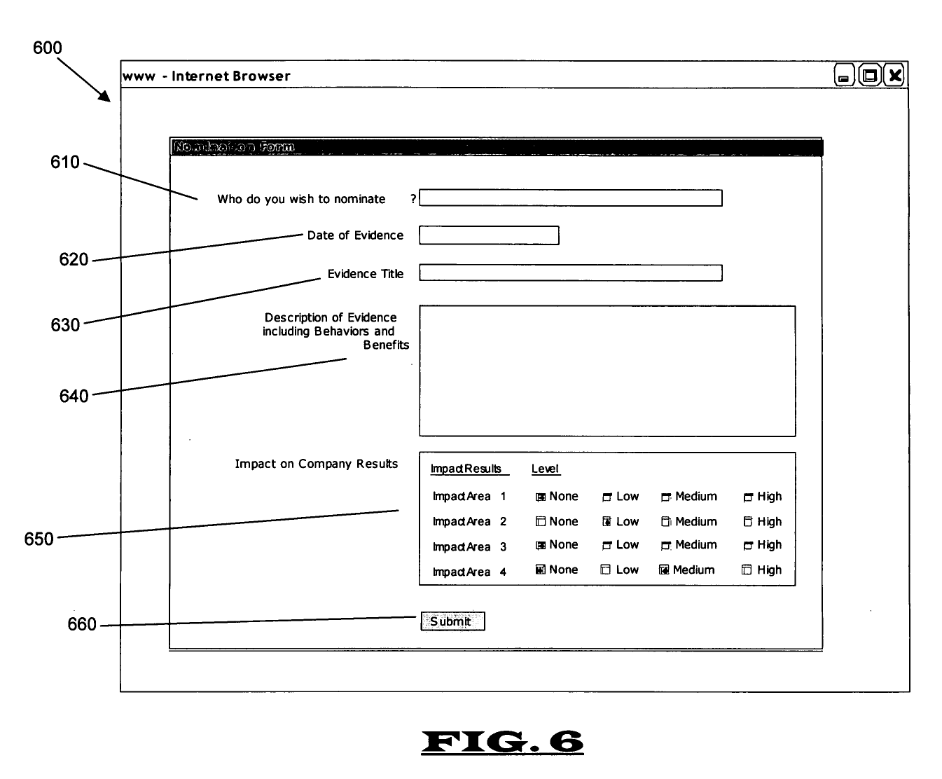

When the user clicks the nomination link or otherwise indicates a desire to submit a nomination, embodiments present a nomination page 600 such as that seen in FIG. 6, preferably a form providing fields for entry of relevant data, such as name of nominee 610, Evidence date 620, Evidence name/title 630, and Evidence description 640 including what the Witness (the user nominating) observed. Additionally, embodiments can provide information about the elements of the job position the nominee holds, such as in the form of links to the elements or in the form of text included on the nomination form. To provide proper such elements, the nomination form can be reloaded once the Witness has entered the nominee name, or a JavaScript or AJAX™ script or the like can search for the relevant elements once the nominee name has been entered. Additional data is preferably requested on the form, such as the effect of the Behaviors on various aspects of the organization. For example, as seen in FIG. 6, a list of aspects 650 can be provided, each having accompanying radio buttons, check boxes, pull-down menus, or the like allowing selection of the degree of impact on the respective aspect. Means for submission of the form is preferably provided in embodiments, such as a “Submit” button 660 as is known in the art of web page design. The nomination form is preferably nested in a page that includes the navigation section and links to relevant sections of the program site, such as the overall mission of the organization, definitions, and the like.

The result of clicking a link in the section reporting on Evidence of others will vary with the type of links provided in the section. If the link is for a specific, randomly presented item, then embodiments present the user with the details of the item. If the link is to one of the plurality of views, embodiments will either reload the page with the view selected, and proper respective items detailed or linked, or will present the user with a page dedicated to the selected view, again with proper respective items either detailed or linked, or to a reports page, such as the reports page 700 shown in FIG. 7 that will be described below.

The user home page 400 can include a quizzes section 425 in which a link can be provided or in which on or more quiz questions can be displayed. Clicking a link in the Quizzes section 425 preferably presents the user of embodiments with a series of interactive questions. In embodiments, the quizzes can appear in the quizzes section 425 of the employee home page 400, particularly when implemented in AJAX™, or can appear in a separate page and/or window. For example, a textual question can be followed by buttons, text entry fields, or the like allowing the user to provide an answer to the question. Once the questions of a given quiz are answered, the user can submit the answers via, for example, a “Submit” button or the like. In embodiments, the user is provided immediate feedback as to his or her performance on a quiz by being directed to a Results page upon submission of a quiz, the Results page presenting the answers the user provided, the answers expected, and/or a rating based upon the number of correct responses. The Results page can include links to additional explanations of answers should the user desire to pursue self-education in the particular areas in which the links are provided. The Quizzes allow a user to self-educate, reinforcing the strategy of the organization as it applies to the user, the behaviors required under the strategy, and can include allowing the user to earn points for completion of Quizzes.

Clicking a link to the Reports section of the site of embodiments can include listing the nominations the user has made and their respective status, a statement of the user's points accrued and redeemed and for what the various point amounts were earned/redeemed, and/or the points accrued for the user's team. This can comprise part of reviewing nominations 270 according to embodiments of the method of implementation. An example of a reports page is seen in FIG. 7, and preferably includes a system dashboard 710 that can display information 730 by various categories presented, for example, in a pull-down menu 720 or the like, though it should be recognized that any suitable selection arrangement could be used in place of the pull-down menu 720. The information 730 displayed in the dashboard section can include the number of nominations in a given period, the number of accepted nominations, the amount of employee access, the number of first time Witnesses and Stewards, and/or any other information the system administrators deem suitable for display in this section.

The Reports page 700 also preferably includes an employee reports section 740 in which, by selecting various criteria from a pull-down menu 750 or the like, reports or context-sensitive links to reports 760 providing more detailed information can be displayed. And additional performance impact section 770 can be included in which a pull-down menu 780 or the like can be used to select criteria by which to view impact of nominations on the organization 790.

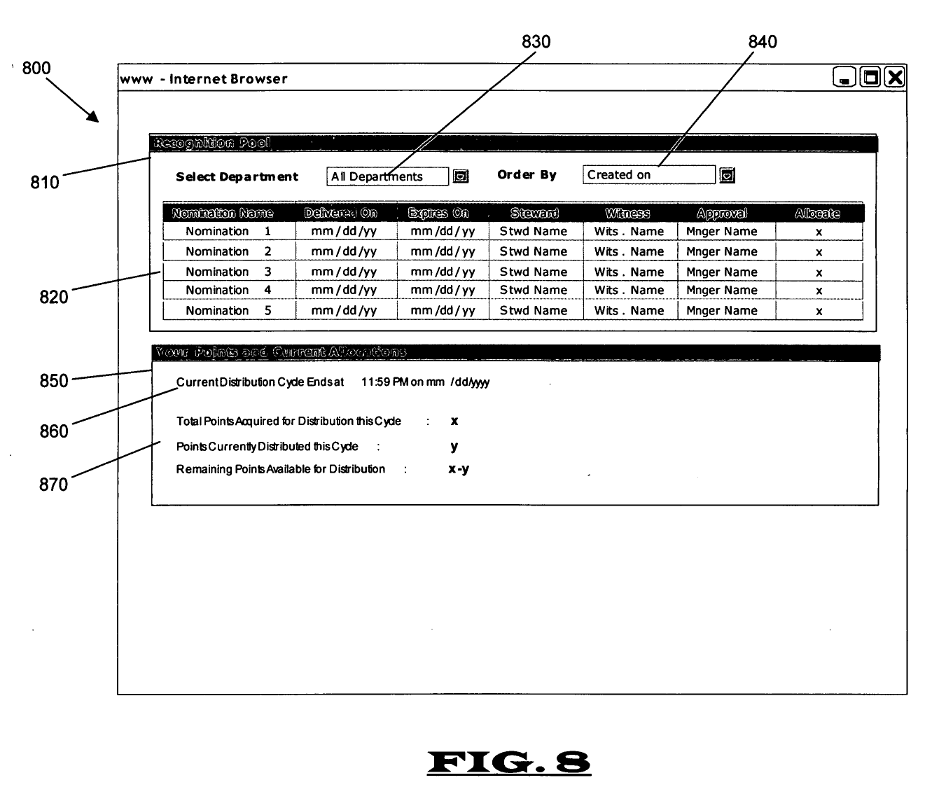

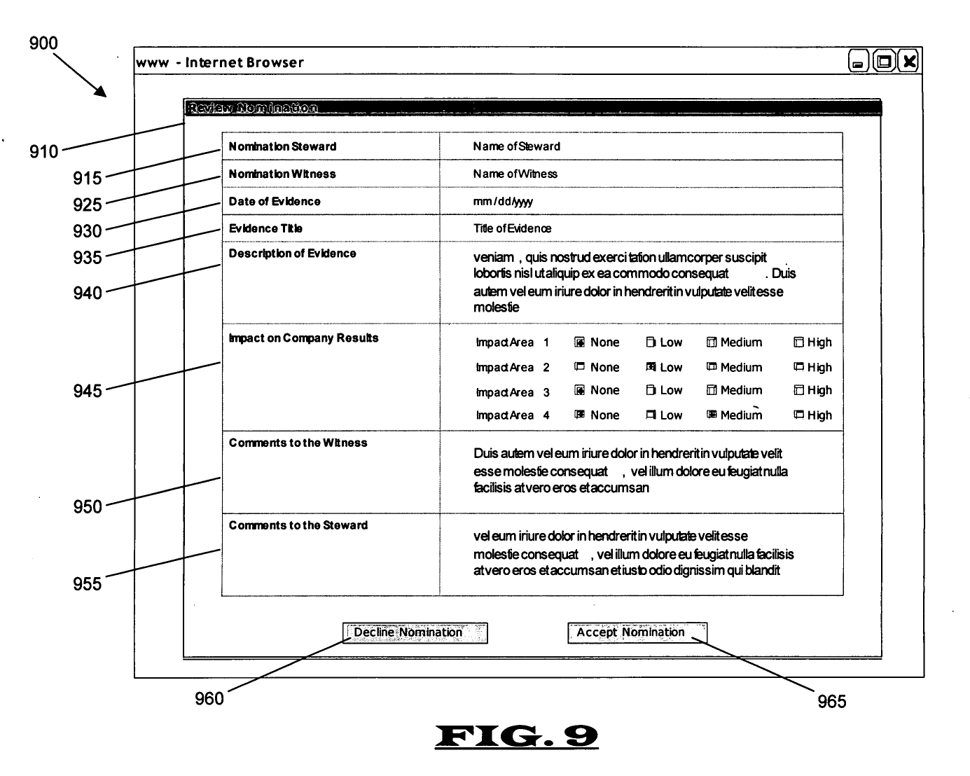

At the manager level, additional reports can be viewed, such as nominations made and points allocation, as seen, for example, in FIG. 8. Reportable statistics, like nominations per employee, total “impact level” of nominations, cross-pollenation witnessing, and nominations by department, help make the “invisible,” hard to quantify behaviors visible and aligned with business results. The page 800 shown in FIG. 8 can include a recognition pool viewing/managing section 810 in which nominations 820 are preferably presented in lists of single line entries that can be linked to detailed information pages for each nomination. For managers, an example of a nomination review page is seen in FIG. 9 and will be described below. The transaction/nomination list 820 items can also be linked to pages providing details about the Evidence for which points were earned and/or items/services for which points were redeemed. Each nomination entry can display an identifier, the date of observation, an expiration date, the nominee/Steward and nominator/Witness name, the name of the approving manager, and/or how many points are to be allocated, though additional information can be displayed as deemed appropriate by the system administrator. To aid in the management of the recognition pool during the point allocation process, the page 800 can include a point allocation section 850 in which information, such as distribution cycle 860 and points acquired/distributed/remaining for distribution 870 can be displayed.

An example of a nomination review page 900 is shown in FIG. 9. Preferably, the nomination review page includes a nomination review section 910 including Steward name 910, Witness name 920, date of Evidence 925, title of Evidence 930, Evidence description 935, impact on organization 940, and/or comments to the Witness 945 and to the Steward 950. Additional or less information can be provided in the nomination review section 910 as deemed appropriate by the program administrator. The nomination review section 910 preferably includes a decline button 955 and an accept button 960, though it can include other suitable elements to allow indication of acceptance or declination of the nomination.

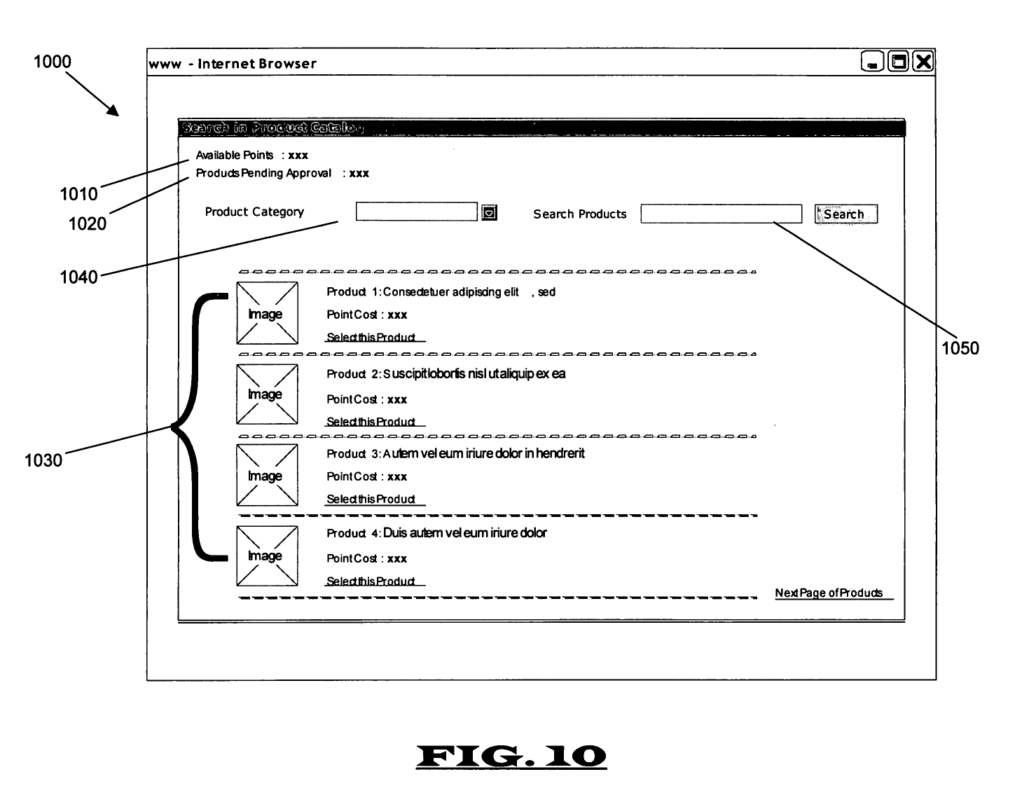

As mentioned above, participants accrue a balance of reward points that can be redeemed for items, services, and the like. To allow redemption of points, embodiments preferably include a point redemption page 1000 to which the redemption link from the user home page 400 links, if included. An example of a point redemption page is provided in FIG. 10. As can be seen in the FIG., the redemption page can include a display of points available for redemption 1010, a display of redemption orders pending approval 1020, and a list of items 1030 that can be presented along with their cost in reward points, similar to many online shopping and reward redemption pages. Additionally, embodiments can include navigation elements, such as product category selector 1040 and search element 1050.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. An organizational strategy reinforcing and educating recognition distribution method comprising:
developing an organization strategy;
defining evidence comprising observable behaviors and experiences that represent aspects of the organization strategy or have an effect on achieving objectives of the organizational strategy;
distributing information about the organization strategy and the evidence; and
recognizing a participant based on behaviors of the participant observed and comprising evidence exhibited by the participant perceived as furthering the strategy of the organization, thereby rewarding understanding and furtherance of the organizational strategy.

2. The method of claim 1 further comprising providing an evidence reporting arrangement and allowing a first participant observing behavior of a second participant to use the evidence reporting arrangement to nominate the second participant for recognition.

3. The method of claim 2 further comprising rewarding both the first and second participants if the nomination is approved, thereby rewarding both the first and second participants for understanding and furthering the organizational strategy.

4. The method of claim 3 further comprising allowing adjustment of the rewards for the first and second participants.

5. The method of claim 3 further comprising providing a larger reward to the first participant than to the second participant.

6. The method of claim 2 wherein recognizing comprises rewarding the participant by presenting the participant with points that the participant can redeem.

7. The method of claim 6 further comprising providing rewards which the participants can collect by redeeming points.

8. The method of claim 1 further comprising providing a computer software application with which at least distributing information, providing evidence reporting, and allowing nominations can be performed.

9. The method of claim 8 wherein the computer software application is web based and comprises an extensible markup language.

10. The method of claim 8 wherein the computer software application comprises scripts.

11. The method of claim 10 wherein the scripts comprise AJAX scripts.

12. The method of claim 10 wherein the scripts comprise Javascript scripts.

13. A method of distributing recognition and reinforcing organizational focus comprising:
providing a server computer;
providing a computer software application;
hosting the computer software application on the server computer as part of a recognition program;
distributing information about a strategy of an organization with the computer software application;
receiving submissions of nominations for recognition of participants in the recognition program by other participants with the computer software application;
providing information about participant progress in the recognition program with the computer software application;
reviewing nominations on a periodic basis; and
for approved nominations, recognizing nominating participants and nominated participants, thereby rewarding both nominating and nominated participants for understanding and furthering the organizational strategy.

14. The method of claim 13 wherein providing a computer software application comprises providing a database for storing data related to the recognition program.

15. The method of claim 13 wherein providing a computer software application comprises providing a web-based application in a markup language.

16. The method of claim 13 wherein distributing information comprises providing at least one web page displaying information.

17. The method of claim 16 wherein providing at least one web page comprises providing a context-sensitive home page that displays information specific to a participant logged into the application and accessing the home page.

18. The method of claim 17 wherein providing a context-sensitive home page comprises providing a plurality of page sections displaying respective types of information and including links to further related information.

19. The method of claim 18 wherein providing a plurality of page sections comprises providing a message section and distributing information further comprises notifying participants that they have messages with the message section.

20. The method of claim 18 wherein providing a plurality of page sections comprises providing a user Evidence section and distributing information further comprises displaying information about Behaviors and Evidence the user should seek in the user experiences section.

21. The method of claim 18 wherein providing a plurality of page sections comprises providing an organization Evidence section and distributing information further comprises displaying information relating to Evidence of import to the organization in the organization experiences section.

22. The method of claim 18 wherein providing a plurality of page sections comprises providing an others' Evidence section and distributing information further comprises displaying information relating to the Evidence of other participants in the others' experiences section.

23. The method of claim 16 wherein providing at least one web page comprises including a navigation section of at least one of the at least on web page.

24. An improved method of distributing recognition and reinforcing organization strategic objectives comprising:
developing an organization strategy;
defining observable behaviors that comprise evidence of furthering at least one objective of the organization strategy;
distributing information about the organization strategy and the evidence of the strategy;
rewarding a participant based on furtherance of at least one objective of the organization strategy as shown by observed behavior comprising evidence.

25. An improved method of distributing recognition among organization members comprising:
developing criteria for recognition of members;
distributing information about the criteria;
providing a nomination arrangement;
allowing a first member to use the nomination arrangement to nominate a second member for recognition based on criteria the first member observed as being exhibited by the second member;
reviewing nominations received; and
recognizing both the first and second members upon nomination approval.

26. The method of claim 25 further comprising recording criteria used in the nomination arrangement.

27. The method of claim 26 further comprising analyzing recorded criteria to amass statistics regarding the understanding of the criteria by the members, the criteria comprising elements of an organization strategy.

28. The method of claim 26 further comprising recorded criteria to amass statistics regarding the productivity of the organization.

29. The method of claim 26 further comprising displaying reports regarding the recorded criteria.
